(19) United States
(12) Patent Application Publication
(10) Pub. No.: US 2006/0265948 A1
(43) Pub. Date: Nov. 30, 2006

(54) Cellulose fiber cover sheet for application to sown seed for providing selectably advantageous growth conditions

(76) Inventor: Alan Schreiner, San Dimas, CA (US)

Correspondence Address: Law Offices of Henry Bissell IV, 10616 Almond Ave., Oak View, CA, 93022-9233, US

(21) Appl. No.: 11/432,642

(22) Filed: May 11, 2006

Related U.S. Application Data
(60) Provisional application No. 60/680,357, filed on May 13, 2005.

(51) Int. Cl. A01G 13/00

(52) U.S. Cl. 47/9

(57) ABSTRACT

Selectably composed cellulose fiber covering for deployment in providing desired aesthetic and environmental conditions, demonstrating significant potential incorporation of recycled/reclaimed materials, facilitated by specialized equipment of varying size and automation, and methods therefore.

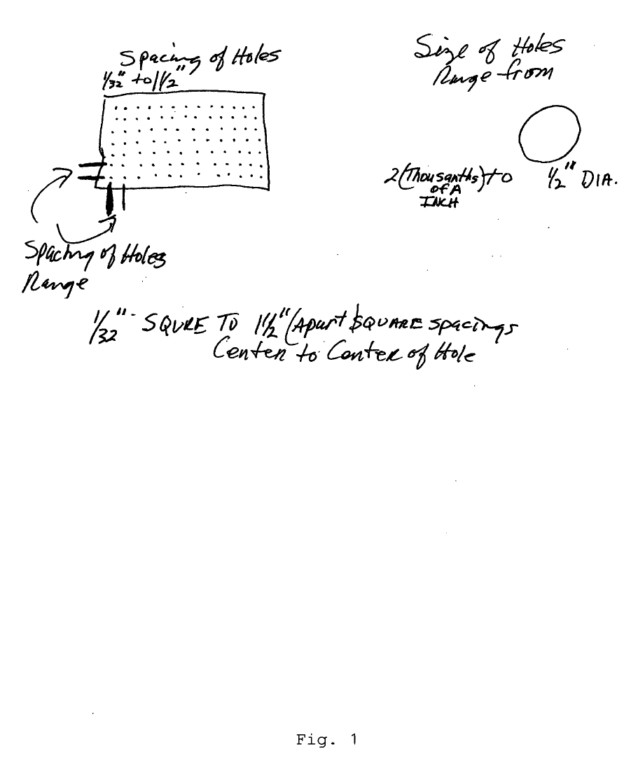

### CROSS-REFERENCE TO RELATED APPLICATION

This application claims the benefit of U.S. Provisional Application No. 60/680,357, filed May 13, 2005.

### BACKGROUND OF THE INVENTION

### Field of the Invention

The present invention generally relates to methods and equipment for hydro-seeding and, more particularly, to methods and equipment for sowing seed and protecting it throughout the germination stage by means of a protective cellulose fiber covering.

### SUMMARY OF THE INVENTION

The present invention provides methods and equipment for covering sown seed with an unrolled and wetted cellulose fiber cover sheet to provide selectably advantageous conditions for growth.

### DESCRIPTION OF THE PREFERRED EMBODIMENTS

The thickness of the cellulose fiber top cover (tissue roll) may be varied to suit the requirements of the specific application. Some applications will call for use of a heavier or thicker mat (ply). The cellulose fiber top cover may vary from 0.005 (five thousandths) to 0.375 (375 thousandths) inches.

As received from the mill, the tissue roll can be obtained in various wet strengths. The availability of these variable wet strengths allows the use of different strengths for different job demands. For example, by utilizing tissue rolls with a variety of wet strengths, the tissue can be made to fall apart at selected times after deployment. From tissue that disintegrates upon the first watering, to more durable cellulose fiber covers that hold up through being watered many times a day for a number of weeks.

Different seeds and kinds of grass will demand different tissue ply thicknesses and strengths. Job location and other specific requirements will influence the selected tissue ply weight, thickness and strength.

In addition, an amount of crepe (from 3% to 75%) can be incorporated into the tissue by the mill at the time of production. This addition of crepe material can provide important moisture holding capabilities. In addition, it can also be used to adjust the strength of the cellulose mat or roll.

All tissue decomposes in 4 to 12 weeks, after the sowed or planted seed has been established. In addition, the tissue controls, delays, and even prevents most weeds from physically coming through the tissue mat. The tissue also helps prevent sunlight from reaching the weed seeds in the top-soil, thereby limiting photosynthesis and unwanted weed germination. With proper watering, weeds do not stand a chance when grass seed, or any other ground cover seeds is spread in accordance with this method. The desired grass or ground cover seed is established sooner than the weed seed and therefore takes control.

The tissue used by this method is clean and 100% weed free. This is in marked contrast to compost, straw or any other commonly used top covers. And unlike those other top covers, the tissue provides a perfectly even and uniform cover layer.

The available colors of cellulose tissue mat vary significantly. The methods of the present invention are able to work with a wide variety of tissue colors. While white would be the best color for purposes of dying or coloring through watering, other natural color cellulose or tissue rolls can be used.

The brown paper industry makes tissue out of OCC (recycled old cardboard containers). Products manufactured from these tissues are commonly found as brown paper napkins, coffee filters, and paper towels. The virgin pulp available from the mills that grind the wood into wood pulp is naturally brown in color. From that “cardboard brown” stock, the mills employ a bleaching process to generate all varieties of commonly available white tissues and papers. Additionally, colored tissue is made from the bleached, white, virgin pulp and/or fibers.

Most mills prefer not to produce colored tissues and pulp, and many completely refuse to do so, because of the difficulty and time involved. With the methods of the present invention, color can be imparted to the tissue at the time of application over the seed, through the use of dyes and pigments already being used in the hydro-seeding industry. This provides a significant benefit through increased convenience and greatly reduced cost.

The machinery used to apply the roll can be built in a number of ways: from self rolling on the ground to unroll, to suspending the roll and driving or turning the roll to match ground speed, letting the mat gently fall upon the ground as it unrolls. The machinery can be equipped to prepare the soil in a number of ways before seeding, or simply seeding over unprepared soil.

The machinery can level, harrow, rake, float, seed, cover and water. These tasks can be performed separately by a number of machines or, more ideally, incorporated into one machine capable of performing all the required tasks and requiring a minimum number of operators. The machine can sow or plant the seeds or not. If so desired, seed could be sown by other methods and then the machine could be used to apply the cellulose tissue top cover. The machine can be made to do all of the steps or just one—cover with the chosen cellulose top cover.

In most cases, machine/s designed in accordance with the practice of the present invention would have a water supply or tank, to enable even watering of the applied mat after it has been placed on the ground. Watering shortly or immediately after applying the mat to the ground is important, to ensure proper placement of the mat and seed.

The optional addition of dyes or coloring agents, fertilizers, or other products beneficial to germination and growth may be used to enhance any seed sowed by these methods. Coloring of the water can be used to enhance or satisfy appearance requirements for the tissue. However, coloring the tissue may be beneficially incorporated to add temperature to the seed bed. In this way, better and faster germination results. This is particularly true with warm season grasses and ground cover. For this reason, black pigmentation would be most desirable, through absorbing all the sun's rays to build higher seed bed temperatures. This increased seed bed temperature is extremely important for some seeds, such as Bermuda (used on most golf courses in the U.S.) which requires almost 80 degree Fahrenheit temperatures in order to germinate. Other colors, varying shades of green for example, can be used to provide a desirable appearance.

The cellulose fiber mat may provide protection against erosion by proper engineering of the paper/tissue grade. A device, or pin wheel, may be used to impart desired perforations to the mat. The perforation spacing may be from 1/32″ to 1½″, measured from perforation centers. The perforation sizing may be from 0.002″ to 0.5″ diameters, depending upon the desired performance characteristics of the mat. Through the proper combination of perforation size and spacing, and the proper grade of paper/tissue, the protective cover sheet performs as a superior new soil erosion prevention mat, one that sheds water. It functions much like plastic sheet, but will enable germination of seed or crop beneath it, thereby functioning as a greenhouse roof.

Depending upon the size and sophistication of the operation, the machinery required to practice the methods of the present invention would vary significantly to match the application requirements. From hand-operated equipment capable of deploying small 6″ rolls, to large tractor-towed or self-powered machines capable of deploying 40′ wide rolls. You could have machines that unroll a 6″ wide roll for home use in planter boxes, or a machine configured for 20″ wide rolls that pushes like a lawn mower and sows, covers and waters, or just covers and waters after you have spread the seed on the ground. Machines can take on all sizes and functions up to 40-50′ wide. From hooking on the 3-point hitch of a tractor, to being a pulled type machine with many tires for flotation in mind, low psi per square inch would be required for work on the golf course greens.

The pulled machines can range in size, from machines capable of being pulled by small riding mowers or three or four wheel ATVs (All Terrain Vehicles), to large machines requiring full-size four wheel drive tractors. The process of applying the roll of cellulose fiber mat can even be as simple a process as a pipe with a handle on it, rolling out the tissue roll itself, and a garden hose with a spray nozzle to apply tap water as the wetting agent. A pipe shaped like an “L” could be inserted into the core of the tissue roll. A simple push will unroll and control the tissue roll, or bending over and unrolling the roll by hand can achieve the desired result.

In all cases, rolling a prepared, engineered roll of cellulose fiber for top cover on seed provides a perfect uniform cover, unlike trying to spread an even bulk top cover of compost, sand, etc. The tissue top cover provides the added benefit of being capable of adding or building temperature for a higher germination rate, with faster germination times. All in all, the methods of the present invention provide a win/win situation for the end user and crop.

This system is a perfect germination vessel for all seeds that require critical depth placements. It guarantees seed placement and perfect depth control. Grass seeds, if planted more than ⅛ inch deep, will not germinate as they are too deep.

Hydro absorbent materials can be incorporated into the fiber or deployment system to increase and maintain moisture in the zone where the seedlings first sprout and start their root system. Tackifiers can be added to help insure placement and block sunlight to unwanted weed seed present in the soil. Fertilizers can be incorporated in the tissue, seed, or deployed during watering procedures. The right blend of fertilizer and other beneficial products can be designed into the particular application and thereby address all of the differing demands: climate, location, season, desired crop, etc.).

In addition, the tissue and application process could be tailor engineered for soil erosion control. Erosion control can be applied that decomposes after it is used or after a season has passed. The tissues presently used in the development of the methods disclosed herein, are FDA approved as food grade. This provides an added benefit of making the process environmentally conscious.

Finally, as an added benefit, the tissue top cover keeps birds and many other small animals from eating the sown seed. As such, the tissue mat provides a perfect blend of protection and an optimal environment perfect for seed germination.

Although there have been described hereinabove various specific arrangements of Cellulose Fiber Cover Sheet For Application To Sown Seed For Providing Selectably Advantageous Growth Conditions with the invention for the purpose of illustrating the manner in which the invention may be used to advantage, it will be appreciated that the invention is not limited thereto. Accordingly, any and all modifications, variations or equivalent arrangements which may occur to those skilled in the art should be considered to be within the scope of the invention as defined in the annexed claims.

What is claimed is:

1. A sheet for providing selectably advantageous growth conditions, said sheet comprising:
a cellulose fiber covering.

2. The sheet of claim 1, wherein said cellulose fiber covering incorporates a tissue-like material.

3. The sheet of claim 1, wherein said cellulose fiber covering has a selectable general thickness from 0.005 to 0.375 inches.

4. The sheet of claim 3, wherein said cellulose fiber covering is available as rolls or mats of material.

5. The sheet of claim 4, wherein said cellulose fiber covering has a selectable wet strength, which enables a variety of disintegration times.

6. The sheet of claim 3, wherein said cellulose fiber covering incorporates an amount of crepe material consisting of from 3% to 75%.

7. The sheet of claim 6, wherein the incorporation of said crepe material provides selectable moisture retention capabilities to the cellulose fiber covering.

8. The sheet of claim 6, wherein the incorporation of said crepe material allows selectable strength characteristics to the cellulose fiber covering.

9. The sheet of claim of claim 3, wherein said cellulose fiber covering provides a selectable period of disintegration with wetting, ranging from first watering to 12 weeks.

10. The sheet of claim 3, wherein said cellulose fiber covering is free of contaminating weed seed.

11. The sheet of claim 3, wherein said cellulose fiber covering provides selectable colors for purposes of dying or coloring through watering.

12. The sheet of claim 11, wherein said cellulose fiber covering selectable color enable selectable germination environment temperature.

13. The sheet of claim 11, wherein said cellulose fiber covering selectable color may be imparted during the manufacturing process.

14. The sheet of claim 13, wherein said cellulose fiber covering may incorporate selectable color to provide a desired appearance.

15. The sheet of claim 13, wherein said cellulose fiber covering may incorporate selectable color to provide a desired germination environment temperature.

16. A method for hydro-seeding soil, said method comprising the steps of:
sowing seed over a selected area of soil;
applying a protective covering over the area of soil; and
employing one or more applications of aqueous solution to the protective covering.

17. The method of claim 16, wherein said protective covering is applied by means for self-rolling on the ground to achieve unrolling of a provided roll.

18. The method of claim 16, wherein said protective covering is applied by means for suspending and unrolling of a provided roll to match ground speed.

19. Equipment for use in hydro-seeding operations, comprising means for preparing the ground for hydro-seeding, means for conducting the sowing or planting of seed, means for applying a protective cover sheet, and means for dispersing an aqueous solution to a protective cover sheet.

20. The sheet of claim 1, wherein said cellulose fiber covering provides a series of perforations having a width from 0.002 inches to 0.5 inches, and a spacing of the perforations from 0.003125 inches to 1.5 inches.
